(19) United States
(12) Patent Application Publication
(10) Pub. No.: US 2026/0238569 A1
(43) Pub. Date: Aug. 13, 2026

(54) ABNORMALITY DETECTION DEVICE, ABNORMALITY DETECTION SYSTEM, AND ABNORMALITY DETECTION METHOD

(71) Applicant: Mitsubishi Electric Mobility Corporation, Tokyo (JP)

(72) Inventors: Kojiro CHIKAMATSU, Tokyo (JP); Yusuke SETO, Tokyo (JP); Katsuhisa OGASAWARA, Tokyo (JP); Toshinori MATSUI, Tokyo (JP); Hiroshi OKUYAMA, Tokyo (JP)

(73) Assignee: Mitsubishi Electric Mobility Corporation, Tokyo (JP)

(21) Appl. No.: 19/470,815

(22) PCT Filed: May 26, 2023
(86) PCT No.: PCT/JP2023/019646

§ 371 Date: Sep. 30, 2025

(51) Int. Cl. H04L 43/02

(52) U.S. Cl. CPC H04L 43/02

(57) ABSTRACT

An abnormality detection device includes: an abnormality detection unit which determines whether or not communication data has abnormality; a rule update unit which updates a detection rule on the basis of usage status data indicating a usage status of a resource, to generate an updated detection rule in which a range of determination processes to be executed is within the remaining capacity of the resource; and an unexecuted processing management unit which, in a case where there is an unexecuted determination process not executed in the updated detection rule and the storage has a remaining capacity, executes a temporary storage process of storing the communication data and the determination rule for the unexecuted determination process into the storage.

### TECHNICAL FIELD

The present disclosure relates to an abnormality detection device, an abnormality detection system, and an abnormality detection method.

### BACKGROUND ART

In recent years, in an in-vehicle system, electronic control units (ECUs) provided to vehicles are connected via a wired or wireless network so that the ECUs are communicable with each other. In such a system in which a plurality of control devices are connected via a network, for example, it is necessary to timely detect abnormality such as an unauthorized access by a cyberattack. Therefore, functions of monitoring data flowing in the communication network and performing determination for a normal or abnormal state are important in terms of in-vehicle security. Meanwhile, an enormous amount of data flows in the communication network, Therefore, if monitoring and determination processes for the data are not efficiently performed, loads on the ECUs and the gateway become excessive, and as a result, erroneous detection and missed detection can occur. In addition, vehicle control which is the original function of the ECUs might also be disturbed. Such problems are significant particularly in a case where an available resource (hardware resource) is limited.

Considering the above, there is an in-vehicle network device in which a monitoring method for communication data is changed in accordance with a rule defined in advance according to the own vehicle state and the data type, thereby reducing a processing load for detecting unauthorized data (see, for example, Patent Document 1),

### CITATION LIST

### Patent Document

Patent Document 1: Japanese Laid-Open Patent Publication No. 2017-47835

### SUMMARY OF THE INVENTION

### Problem to be Solved by the Invention

According to the technology disclosed in Patent Document 1, monitoring of a part of communication data is simplified in accordance with a rule corresponding to the present own vehicle state, whereby the processing load can potentially be reduced. However, in the technology disclosed in Patent Document 1, the relationship between the rule and the resource state is not always clear, and when monitoring and processing for communication data are executed in accordance with the above rule, resource shortage can occur. In addition, regarding definition of the rule, it is difficult to comprehensively define the rule, including for the own vehicle state that is not normally assumed.

The present invention has been made to solve the above problems, and an object of the present invention is to provide an abnormality detection device, an abnormality detection system, and an abnormality detection method which can achieve abnormality detection by monitoring communication data, while preventing occurrence of resource shortage even in an environment with limited resources.

### Means to Solve the Problem

An abnormality detection device according to the present disclosure includes: a communication control unit which is connected to a network and receives communication data flowing through the network; a detection rule storage unit which stores a detection rule to be used for abnormality detection for the communication data, the detection rule including determination rules indicating determination processes to be used for determining whether or not the communication data has abnormality; an abnormality detection unit which determines whether or not the communication data has abnormality; a resource status management unit which manages a usage status of a resource to be used by the abnormality detection unit, and outputs usage status data indicating the usage status of the resource; a rule update unit which updates the detection rule on the basis of the usage status data, to generate an updated detection rule in which a range of the determination processes to be executed is within a remaining capacity of the resource; and an unexecuted processing management unit which, in a case where there is an unexecuted determination process not executed in the updated detection rule and the storage has a remaining capacity, executes a temporary storage process of storing the communication data and the determination rule for the unexecuted determination process into the storage. The abnormality detection unit determines whether or not the communication data has abnormality, on the basis of the updated detection rule. In a case where the temporary storage process has been executed, the abnormality detection unit executes the unexecuted determination process when the remaining capacity of the resource that enables execution of the unexecuted determination process is ensured.

An abnormality detection system according to the present disclosure includes: a communication control unit which is connected to a network and receives communication data flowing through the network; a detection rule storage unit which stores a detection rule to be used for abnormality detection for the communication data, the detection rule including determination rules indicating determination processes to be used for determining whether or not the communication data has abnormality; a first abnormality detection unit which determines whether or not the communication data has abnormality; a second abnormality detection unit which uses a resource physically or logically separated from a resource to be used by the first abnormality detection unit; a resource status management unit which manages a usage status of the resource to be used by the first abnormality detection unit, and outputs usage status data indicating the usage status of the resource; a rule update unit which updates the detection rule on the basis of the usage status data, to generate an updated detection rule in which a range of the determination processes to be executed is within a remaining capacity of the resource; and an unexecuted processing management unit which, in a case where there is an unexecuted determination process not executed in the updated detection rule and a communication device has a remaining capacity, executes a transfer process of causing the communication device to transmit the communication data and the determination rule for the unexecuted determination process to the second abnormality detection unit. The first abnormality detection unit determines whether or not the communication data has abnormality, on the basis of the updated detection rule. The second abnormality detection unit executes the unexecuted determination process in a case where the transfer process has been executed.

An abnormality detection method according to the present disclosure is an abnormality detection method for detecting abnormality of communication data flowing via a network, the method includes: a step of managing a usage status of a resource to be used for determining whether or not the communication data has abnormality, and outputting usage status data indicating a usage status of the resource; a step of updating, on the basis of the usage status data, a detection rule which is used for abnormality detection for the communication data and includes determination rules indicating determination processes to be used for determining whether or not the communication data has abnormality, and generating an updated detection rule in which a range of the determination processes to be executed is within a remaining capacity of the resource; a step of, by a first abnormality detection unit, determining whether or not the communication data has abnormality, on the basis of the updated detection rule; a step of, in a case where there is an unexecuted determination process not executed in the updated detection rule and a communication device has a remaining capacity, executing a transfer process of causing the communication device to transmit the communication data and the determination rule for the unexecuted determination process to a second abnormality detection unit which uses a resource physically or logically separated from a resource to be used by the first abnormality detection unit; and a step of, in a case where the transfer process has been executed, executing the unexecuted determination process by the second abnormality detection unit.

### Effect of the Invention

With the abnormality detection device, the abnormality detection system, or the abnormality detection method according to the present disclosure, it is possible to achieve abnormality detection by monitoring communication data, while preventing occurrence of resource shortage even in an environment with limited resources.

### BRIEF DESCRIPTION OF THE DRAWINGS

FIG. 1 is a block diagram showing a configuration of an abnormality detection system in embodiment 1.

FIG. 2A shows an example of a detection rule according to embodiment 1, which is a detection rule before update.

FIG. 2B shows an example of a detection rule according to embodiment 1, which is a detection rule after update.

FIG. 3A shows another example of a detection rule according to embodiment 1, which is a detection rule before update.

FIG. 3B shows another example of a detection rule according to embodiment 1, which is a detection rule after update.

FIG. 4 shows an example of a hardware configuration of an abnormality detection device in embodiment 1.

FIG. 5 is a flowchart showing operation of the abnormality detection system in embodiment 1.

FIG. 6 is a flowchart showing a rule update process according to embodiment 1.

FIG. 7 is a flowchart showing an abnormality detection process according to embodiment 1.

FIG. 8 is a flowchart showing operation in executing an unexecuted determination process in embodiment 1.

FIG. 9 is a block diagram showing a configuration of an abnormality detection system in embodiment 2.

FIG. 10A shows an example of a detection rule according to embodiment 2, which is a detection rule before update.

FIG. 10B shows an example of a detection rule according to embodiment 2, which is a detection rule after update.

FIG. 11 shows examples of detection logs according to embodiment 2, which are detection logs respectively generated by different abnormality detection units and a detection log obtained by integrating the detection logs.

FIG. 12 is a flowchart showing an abnormality detection process according to embodiment 2.

FIG. 13 is a flowchart showing operation in executing an unexecuted determination process in embodiment 2.

FIG. 14 is a block diagram showing a configuration of an abnormality detection system in embodiment 3.

FIG. 15 is a flowchart showing an abnormality detection process according to embodiment 3.

### DESCRIPTION OF EMBODIMENTS

### Embodiment 1

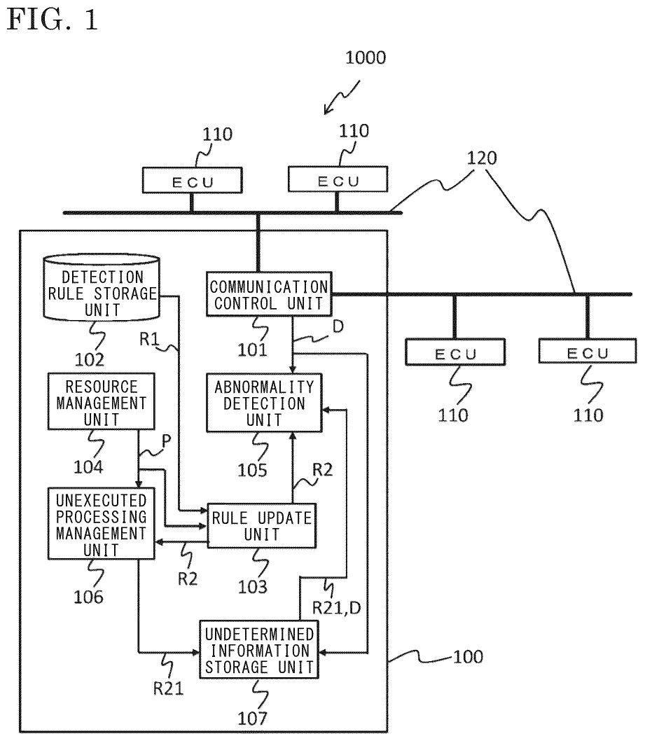

Embodiment 1 will be described with reference to FIG. 1 to FIG. 8. FIG. 1 is a block diagram showing a configuration of an abnormality detection system in embodiment 1. An abnormality detection system 1000 is configured such that an abnormality detection device 100 and an ECU 110 are connected via a network, here, an in-vehicle network 120. In the abnormality detection device 100, the number of the ECUs 110 is not particularly limited. Each ECU 110 transmits and receives communication data via the in-vehicle network 120. The plurality of ECUs 110 and the in-vehicle network 120 form one in-vehicle system.

The abnormality detection device 100 includes: a communication control unit 101 which is connected to the in-vehicle network 120 and which receives communication data D flowing through the in-vehicle network 120 and transmits data such as an abnormality detection result to the in-vehicle network 120 as necessary; a detection rule storage unit 102 which stores a detection rule R1 which is a detection rule for abnormality detection; a rule update unit 103 which updates the detection rule R1 in accordance with a usage status of a resource of the abnormality detection device 100; a resource management unit 104 which manages the usage status of the resource of the abnormality detection device 100; and an abnormality detection unit 105 which detects abnormality of communication data D flowing through the in-vehicle network 120, on the basis of an updated detection rule R2. The abnormality detection device 100 includes an unexecuted processing management unit 106 which changes an abnormality detection process on the basis of the updated detection rule R2, and an undetermined information storage unit 107 which stores information about a determination process that has not been executed yet. As the “resource” in embodiment 1, a hardware resource to be used for implementing functions of the abnormality detection device 100 is shown and the details thereof will be described later.

The structure and the network architecture shown in FIG. 1 are merely an example, and a structure and a network architecture other than those shown in FIG. 1 may be adopted as long as the communication control unit 101, the detection rule storage unit 102, the abnormality detection unit 105, the resource management unit 104, the rule update unit 103, the unexecuted processing management unit 106, and the undetermined information storage unit 107 are provided and they are connected to one or more ECUs 110 via one or more in-vehicle networks 120. For example, instead of providing all the components shown in the example in FIG. 1 to the abnormality detection device 100, some of the components may be transferred to another device connected to the in-vehicle network 120, and the other device may transmit and receive necessary data via the in-vehicle network 120. That is, configurations of the function units included in the abnormality detection device 100 may be provided in corresponding ones of a plurality of devices connected to a network through which they can communicate with each other in the abnormality detection system 1000, so that the abnormality detection system 1000 as a whole has the function units of the abnormality detection device 100 shown in FIG. 1. The abnormality detection device 100 may be configured as a device dedicated for abnormality detection or may be configured to have also a function as an ECU. In addition, the abnormality detection device 100 may have also functions of a gateway control device for relaying communication between the ECUs 110, an engine control device, an electric power steering (EPS) control device, an advanced driver assistance system (ADAS) control device, and the like.

The communication control unit 101 is implemented by a communication device 84 described later, and transmits and receives communication data D to and from the ECUs 110 via the in-vehicle network 120. The in-vehicle network 120 may be a control area network (CAN) or Ethernet (registered trademark), for example, and is not limited thereto. The ECUs 110 are not particularly limited as long as they transmit and receive communication data D via the in-vehicle network 120. The communication control unit 101 transmits the received communication data D to the abnormality detection unit 105 and the undetermined information storage unit 107, as necessary.

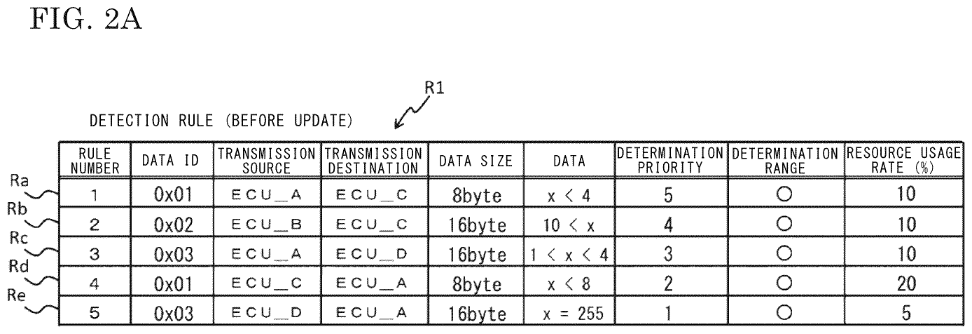

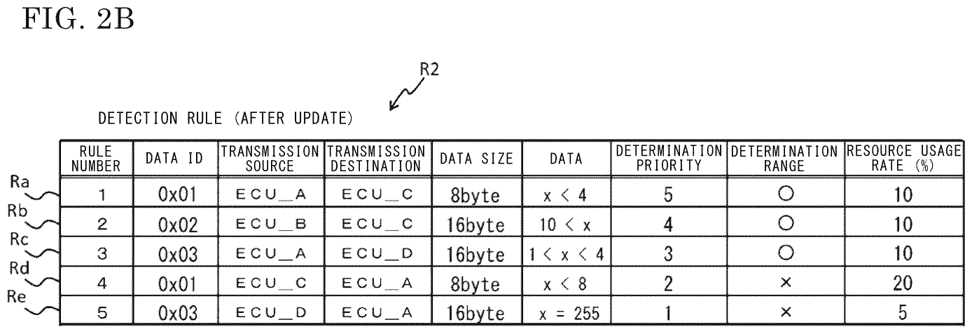

The detection rule storage unit 102 stores the detection rule R1. The detection rule R1 is defined in advance, and is a rule for determining whether or not communication data transmitted/received by the communication control unit 101 is normal. FIG. 2A shows an example of a detection rule according to embodiment 1 and shows a detection rule R1 which is a detection rule before update. As shown in FIG. 2A, the detection rule RI before update includes a list of determination rules composed of five determination rules Ra to Re, for example, Each determination rule includes a “rule number”, a “data ID”, a “transmission source” a “transmission destination”, a “data size”, “data”, a “determination priority”, a “determination range”, and a “resource usage rate”, and is used for determination as to whether or not the communication data D has abnormality.

The “rule number” is a number uniquely indicating each determination rule. The “data ID” is an ID of the communication data D. The “transmission source” and the “transmission destination” indicate a device (ECU 110) that is a transmission source and a device (ECU 110) that is a transmission destination when the communication data D is transmitted and received via the in-vehicle network 120. The “data size” is a data size of the communication data D, and the “data” indicates a specific value or range of data.

The “determination priority” indicates a priority for executing a determination process corresponding to the determination rule, and a determination process corresponding to a determination rule having a higher determination priority is preferentially executed. The “determination range” indicates whether or not the determination process corresponding to the determination rule is executed by the abnormality detection unit 105. In a case of a circle mark (o), the determination process is executed, and in a case of a cross mark (x), the determination process is not executed. However, as described later, the determination process that is not executed is also executed later in accordance with the usage status of the resource. The “resource usage rate” is a resource usage rate (a usage rate of a resource consumed when determination process is executed) needed in a case of executing the determination process corresponding to the determination rule.

The detection rule R1 shown in FIG. 2A is a detection rule in a so-called “whitelist manner”, and is an example of a rule regarding the communication data D in a normal state. That is, a determination process is performed to determine whether or not the communication data D which is a determination target coincides with the content indicated by each determination rule, sequentially from the determination rule having the highest determination priority. Then, if the communication data D which is a determination target coincides with the content of one of the determination rules, the communication data D is determined to be normal. In comparison between the communication data D and each determination rule, they are determined to “coincide” with each other only if they are matched for all items, and they are determined to “not coincide” with each other if they are not matched for one item. For example, in a case where the data ID of the communication data D which is a determination target is 0x01, the transmission source is ECU_C, the transmission destination is ECU_A, the data size is 8 bytes, and the value of data x is 7, the communication data D is not matched with the determination rule Ra of the rule number 1 which has the highest determination priority and is used first for determination, regarding the transmission source and the like, and thus is determined to “not coincide”. Subsequently, the communication data D undergoes determination using the determination rules Rb and Rc of the rule numbers 2 and 3, and is determined to “not coincide” because the data ID is not matched. In determination corresponding to the determination rule Rd of the rule number 4, the communication data D is matched for all the items and thus is determined to “coincide”, so that the communication data D is determined to be normal and the determination processes are finished. If the value of the data x is 10, the communication data D is determined to “not coincide” with the determination rule Rd of the rule number 4 as well, and in subsequent determination corresponding to the determination rule Re, the communication data D is determined to “not coincide” because the data ID is not matched. Thus, the communication data D does “not coincide” with all the determination rules and is determined to be “abnormal”, so that abnormality is detected.

The detection rule R1 is not limited to that shown in FIG. 2A, as long as whether or not the communication data D is normal can be determined with the detection rule. The items in the determination rules Ra to Re also can be arbitrarily set, and other items may be adopted as long as each determination rule can be uniquely identified with an item, whether or not the communication data D is normal can be determined with an item, and such items can be used by the abnormality detection unit 105 and the rule update unit 103.

The rule update unit 103 updates the detection rule R1 on the basis of the usage status of a resource of the abnormality detection device 100, to generate the updated detection rule R2. FIG. 2B shows an example of a detection rule according to embodiment 1, which is a detection rule after update. In the rule update unit 103, regarding the updated detection rule R2 shown in FIG. 2B, it is assumed that the remaining capacity (a resource available for abnormality detection) of the resource is 30% in usage rate, and the detection rule RI before update is updated so that the sum of the resource usage rates for the determination rules included in the determination range (the “determination range” is “o”) is not greater than 30%. The rule update unit 103 recognizes the present usage status of the resource by receiving usage status data P indicating the usage status of the resource from the resource management unit 104, and updates the detection rule RI so as to include more determination rules in the determination range within a range executable with the remaining capacity (here, 30%) of the resource. The rule update unit 103 preferentially causes determination rules having higher determination priorities to be included into the determination range, In the example shown in FIG. 2B, although all the determination rules Ra to Re are included in the determination range in the detection rule R1 before update, in the updated detection rule R2, only the determination rules Ra to Rc are included in the determination range, and the determination rules Rd and Re are excluded from the determination range. Thus, the sum of the resource usage rates for the determination rules included in the determination range becomes 30%. As described above, in the updated detection rule R2, the range of determination processes to be executed is within the remaining capacity of the resource.

The rule update unit 103 transmits the updated detection rule R2 to the abnormality detection unit 105 and the unexecuted processing management unit 106.

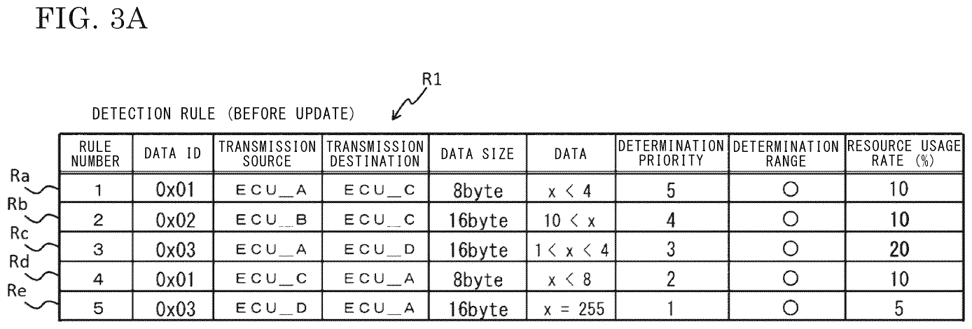

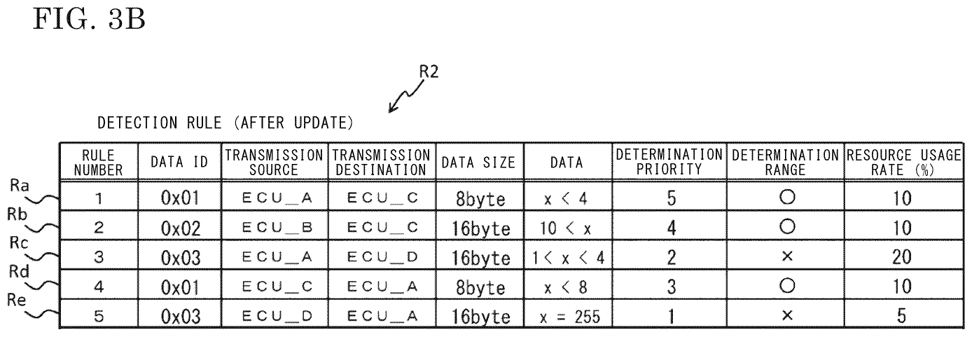

The items to be updated in update of the detection rule R1 by the rule update unit 103 are the “determination priority” and the “determination range”. The reason for updating the “determination priority” is that there is a case where abnormality detection can be efficiently performed when determination rules for which the resource usage rates are small are prioritized. For example, in other examples of detection rules shown in FIG. 3A and FIG. 3B, the resource usage rate for the determination rule Rb is 20% and the resource usage rate for the determination rule Rc is 10%. In this case, if determination rules are merely included in the determination range in the descending order of determination priority from the highest one without changing the determination priorities, the resource usage rate reaches 40% when the determination rule Rc is included in the determination range, and therefore only the determination rules Ra and Rb can be included in the determination range. In addition, the resource ends up having a remaining capacity of 10%. Considering the above, in the updated detection rule R2 shown in FIG. 3B, the determination priority of the determination rule Rc is updated to “2” and the determination priority of the determination rule Rd is updated to “3”. Thus, in the updated detection rule R2, the determination rules included in the determination range are three determination rules Ra, Rb, and Rd. In addition, the remaining capacity 30% of the resource is fully used. Therefore, abnormality detection can be more efficiently performed than in a case of not updating the determination priorities. By updating the determination priorities as described above, a combination of determination rules that minimizes a difference between the remaining capacity of the resource and the sum of resource amounts needed for determination processes to be executed may be generated, and determination processes corresponding to the combination of the determination rules may be included into the determination range.

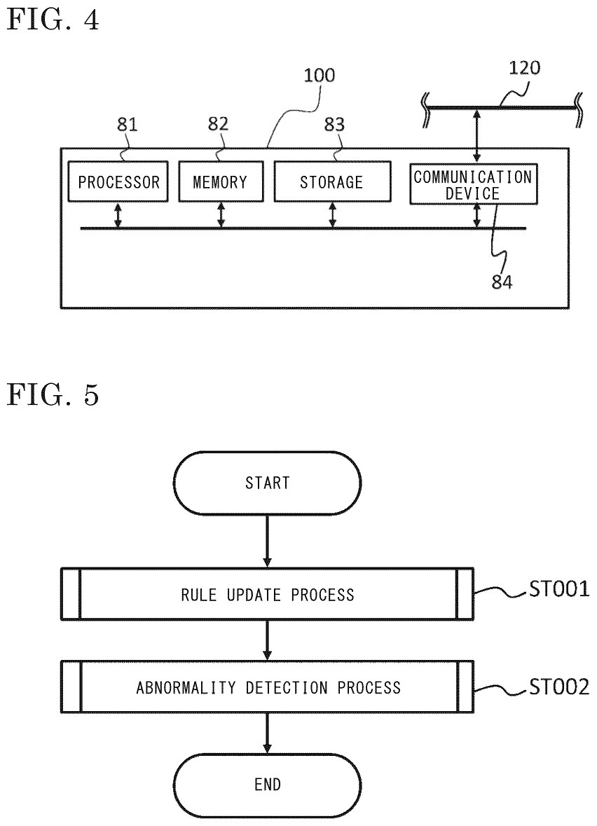

The resource management unit 104 manages the usage status of the resource included in the abnormality detection device 100. The “resource” in embodiment 1 refers to a hardware resource to be used for implementing the functions of the abnormality detection device 100, and is a resource to be used when the abnormality detection unit 105 executes determination processes. In a case where the abnormality detection device 100 has also a function of an ECU or the like, the resource is used also for implementing the function of the ECU or the like. Specific examples of the “resource” include a processor, a memory, a storage, and a communication device. FIG. 4 shows an example of a hardware configuration of the abnormality detection device in embodiment 1.

The functions of the abnormality detection device 100 are executed by a hardware configuration as shown in FIG. 4. Specifically, the abnormality detection device 100 is mainly composed of a processor 81, a memory 82 as a main storage device, and a storage 83 as an auxiliary storage device. The processor 81 is composed of, for example, a central processing unit (CPU), an application specific integrated circuit (ASIC), a digital signal processor (DSP), a field programmable gate array (FPGA), and the like. The memory 82 is composed of a volatile storage device such as a random access memory (RAM), and the storage 83 is composed of an embedded multimedia card (eMMC), a nonvolatile storage device such as a flash memory, a hard disk, or the like.

The storage 83 stores a predetermined program to be executed by the processor 81, and the processor 81 reads and executes the program as appropriate, to perform various calculation processes. In this case, the predetermined program is temporarily stored into the memory 82 from the storage 83, and the processor 81 reads the program from the memory 82. A calculation process by each function unit shown in FIG. 1 is implemented by the processor 81 executing the predetermined program as described above. A result of the calculation process by the processor 81 is stored into the memory 82 once, and is stored into the storage 83 in accordance with the purpose of the executed calculation process.

The abnormality detection device 100 includes the communication device 84 for implementing transmission and reception of data to and from an external device via the in-vehicle network 120, The communication device 84 is, for example, a network interface card (NIC), but is not limited thereto.

The usage status of the resource managed by the resource management unit 104 includes, for example, the usage rate and the processing speed of the processor 81, the usage amount of the memory 82, the usage amount of the storage 83, and the communication band and the communication speed of the communication device 84.

The resource management unit 104 acquires and stores the usage status of the resource included in the abnormality detection device 100. The resource management unit 104 transmits data of the stored usage status as usage status data P to the rule update unit 103 and the unexecuted processing management unit 106. The resource management unit 104 updates the stored usage status of the resource, as needed. The frequency, the timing, and the range of the update may be arbitrarily determined.

The abnormality detection unit 105 receives the communication data D via the communication control unit 101, and executes a determination process for the communication data D, to determine whether or not the communication data D is normal and thus determine whether or not there is abnormality, thereby detecting abnormality of the communication data D. The abnormality detection unit 105 executes the above determination process on the basis of the updated detection rule R2. The specific content of the determination process is as described above. The abnormality detection unit 105 outputs a determination result as a detection log (not shown). The detection log may be stored in the abnormality detection device 100, or may be transmitted (reported as an abnormality detection result) to the ECU 110 or the like via the in-vehicle network 120.

In the updated detection rule R2, there is a possibility that some or all of the determination rules are not included in the determination range and determination processes by the abnormality detection unit 105 are not executed for some or all of the determination rules. The determination processes that have not been executed are executed after processes by the unexecuted processing management unit 106 and the undetermined information storage unit 107 as described below.

The unexecuted processing management unit 106 changes the execution method for determination processes on the basis of the usage status of the resource, in a case where there is a determination rule not included in the determination range in the updated detection rule R2 and there is a determination process that has not been executed in the abnormality detection unit 105. The unexecuted processing management unit 106 receives the updated detection rule R2 from the rule update unit 103, and receives the usage status data P from the resource management unit 104. While there are various cases where some of determination processes are not executed due to the usage status of the resource, in embodiment 1, a case where some of determination processes cannot be executed due to shortage of the remaining capacity in the usage rate or the processing speed of the processor 81 or the usage amount of the memory 82, will be described as an example. The unexecuted processing management unit 106 executes a temporary storage process of acquiring information about the remaining capacity of the storage 83 from the usage status data P and storing an unexecuted detection rule R21 and the communication data D which is a determination target into the undetermined information storage unit 107, in accordance with the remaining capacity of the storage 83. As the communication data D which is a determination target, data received by the communication control unit 101 is stored. The unexecuted detection rule R21 is a part of the updated detection rule R2, and is obtained by extracting only determination rules for which the determination range is “x” from the determination rules Ra to Re of the updated detection rule R2. In the case of the updated detection rule R2 shown in FIG. 2B, the unexecuted detection rule R21 is composed of the determination rules Rd and Re. In the updated detection rule R2, a determination process corresponding to the determination rule for which the determination range is “x” corresponds to an “unexecuted determination process”.

In a case of having executed the temporary storage process, the unexecuted processing management unit 106 regularly receives the subsequent usage status data P, to monitor the latest usage status of the resource. The unexecuted processing management unit 106 determines, as appropriate, whether or not the remaining capacity of the resource (the usage rate or the processing speed of the processor 81 or the remaining capacity in the usage amount of the memory 82) needed for executing determination processes corresponding to the determination rules Rd and Re composing the unexecuted detection rule R21 can be ensured, and at the timing when it is determined that the remaining capacity of the resource can be ensured, the unexecuted processing management unit 106 causes the unexecuted detection rule R21 and the communication data D which is a determination target stored in the undetermined information storage unit 107 to be transmitted to the abnormality detection unit 105. The abnormality detection unit 105 executes the determination processes corresponding to the determination rules Rd and Re which have not been executed.

Since the undetermined information storage unit 107 is realized by the storage 83, storing into the undetermined information storage unit 107 corresponds to storing into the storage 83.

As described above, even if the remaining capacity of the resource is limited, first, determination processes are executed within a range executable with the remaining capacity, and then, information about determination processes that are not executed is stored in the undetermined information storage unit 107. At the time when a necessary resource is ensured, the unexecuted determination processes are executed, whereby all the determination processes to be executed are executed without being missed.

Next, operation will be described. FIG. 5 is a flowchart showing operation of the abnormality detection system in embodiment 1. As shown in FIG. 5, the abnormality detection device executes the rule update process (step ST001) and the abnormality detection process (step ST002). Since the abnormality detection process is performed using the updated detection rule R2, the rule update process is performed first. However, since both processes are performed for the communication data D received consecutively, the rule update process and the abnormality detection process are executed independently of each other at arbitrary timings, i.e., each process is executed at an arbitrary timing. For example, only the rule update process may be executed after software is updated or when an accessary power supply is turned on, and the abnormality detection process may be executed after a certain time elapses, for example.

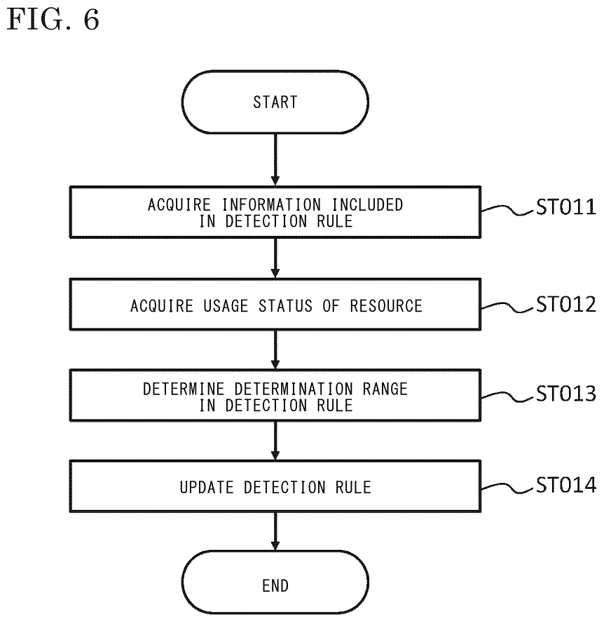

First, the rule update process will be described. FIG. 6 is a flowchart showing the rule update process according to embodiment 1. In the rule update process, first, information included in the detection rule R1 is acquired (step ST011). The rule update unit 103 acquires information about the rule numbers, the determination priorities, and the resource usage rates from the determination rules Ra to Re included in the detection rule R1.

Next, the usage status of the resource is acquired (step ST012). The rule update unit 103 receives the usage status data P from the resource management unit 104, and acquires the remaining capacity of the resource with which the determination processes can be performed by the abnormality detection unit 105, as the usage status of the resource of the abnormality detection device 100. Here, as an example, the remaining capacities of the processor 81 and the memory 82 are acquired.

Next, the determination range in the detection rule is determined (step ST013). On the basis of information about the determination priorities and the resource usage rates acquired in step ST011 and information about the remaining capacity of the resource acquired in step ST012, the rule update unit 103 determines determination rules to be included into the determination range in the order of determination priority within a range in which the sum of the resource usage rates needed for the determination processes corresponding to the determination rules does not exceed the remaining capacity of the resource.

Next, the detection rule is updated (step ST014). The rule update unit 103 updates the determination range (“0” or “x”) for the determination rules as determined in step ST103. The rule update unit 103 transmits the detection rule R1 updated as described above, as the updated detection rule R2, to the abnormality detection unit 105.

The rule update process may be executed at an arbitrary timing, For example, the rule update process may be executed at the timing when the resource management unit 104 updates the usage status (usage status data P) of the resource, or may be executed at the timing when the communication control unit 101 receives the communication data D which is a determination target.

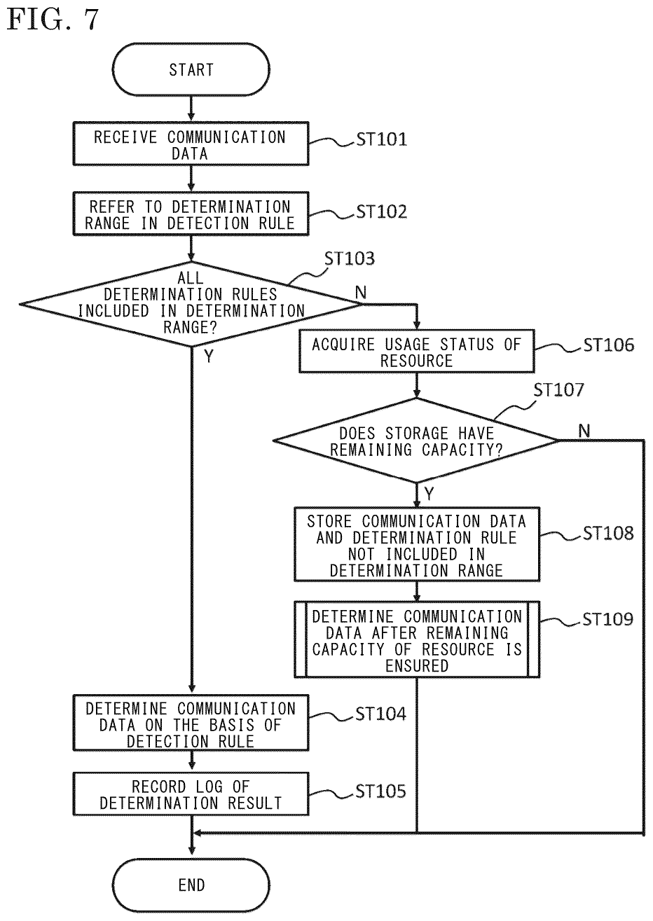

Next, the abnormality detection process will be described. FIG. 7 is a flowchart showing the abnormality detection process according to embodiment 1. First, the communication control unit 101 receives the communication data D (step ST101).

Next, the abnormality detection unit 105 refers to the determination range in the detection rule (updated detection rule R2) (step ST102).

In the updated detection rule R2, if all the determination rules are included in the determination range, the process proceeds to step ST104, and if there is a determination rule not included in the determination range, the process proceeds to step ST106 (step ST103).

If all the determination rules are included in the determination range (step ST103: Y), the abnormality detection unit 105 performs determination for the target communication data D on the basis of the detection rule (updated detection rule R2) (step ST104), and outputs a determination result as a detection log to be recorded (step ST105).

If there is a determination rule not included in the determination range (step ST103: N), first, the usage status of the resource is acquired (step ST106). The unexecuted processing management unit 106 receives the usage status data P from the resource management unit 104, and acquires the usage status of the resource included in the abnormality detection device 100, from the usage status data P. The unexecuted processing management unit 106 determines whether or not the storage 83 has a remaining capacity, on the basis of the acquired usage status of the resource. If the storage 83 has a remaining capacity, the process proceeds to step ST108, and if the storage 83 does not have a remaining capacity, the process is ended.

If the storage 83 has a remaining capacity (step ST107: Y), the communication data D which is a determination target and the determination rules not included in the determination range in the updated detection rule R2 are stored (step ST108: temporary storage process). The undetermined information storage unit 107 stores the communication data D which is a determination target received from the communication control unit 101 and the unexecuted detection rule R21 received from the unexecuted processing management unit 106. As described above, the unexecuted detection rule R21 is composed of determination rules not included in the determination target in the updated detection rule R2.

Next, after the remaining capacity of the resource (here, the remaining capacities of the processor 81 and the memory 82 as described above) is ensured, determination for the communication data D is performed (step ST109). The unexecuted processing management unit 106 regularly receives the usage status data P to update the remaining capacity of the resource. If it is determined that the remaining capacity of the resource has become greater than the resource usage rate needed for the unexecuted determination processes, the process proceeds to step ST109. It suffices that all the determination processes are eventually executed. Therefore, the timing of proceeding to step ST109 may be a timing when the determination processes corresponding to all the determination rules included in the unexecuted detection rule R21 become executable, or the process may proceed to step ST109 as appropriate at a timing when some of the determination processes become executable. The processing in step ST109 is executed at such an uncertain timing that the remaining capacity of the resource for performing the determination processes is sufficiently ensured. Therefore, in a case where there is another abnormality detection process, the process proceeds from step ST108 to step ST104, while step ST109 is separately executed in parallel.

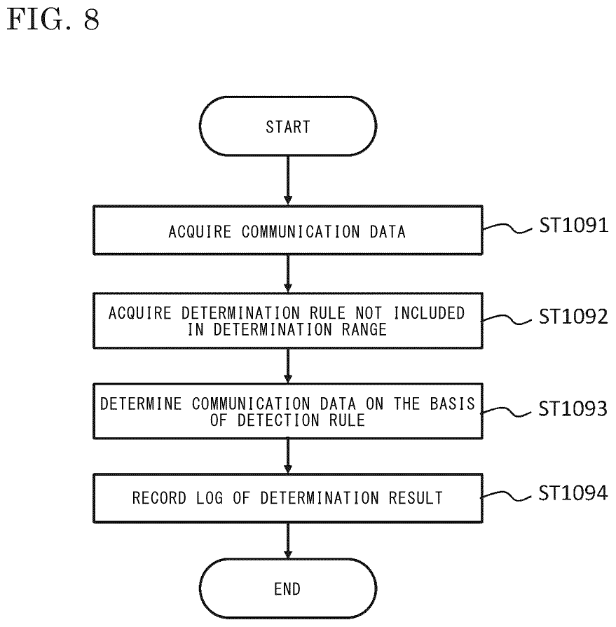

The details of the processing in step ST109 will be described. FIG. 8 is a flowchart showing operation in executing an unexecuted determination process in embodiment 1. First, the communication data D which is a determination target is acquired (step ST1091). The abnormality detection unit 105 acquires the communication data D which is a determination target from the undetermined information storage unit 107.

Next, the determination rules not included in the determination range are acquired (step ST1092). The abnormality detection unit 105 acquires the unexecuted detection rule R21 from the undetermined information storage unit 107, thereby acquiring the determination rules not included in the determination range in the updated detection rule R2.

Next, determination for the communication data is performed on the basis of the detection rule (step ST1093). The same processing as in step ST104 is executed for the determination rules not included in the determination range.

Next, a log of a determination result is recorded (step ST1094). This processing is the same as in step ST105.

In the abnormality detection process, the process in step ST102 and subsequent steps may be executed at each time when communication data D is received, or a certain amount of communication data D may be accumulated as a queue and then may be collectively processed at a certain timing.

According to embodiment 1, even in an environment with a limited resource, occurrence of shortage of the resource can be prevented and abnormality detection through monitoring of communication data can be performed. More specifically, the abnormality detection device includes: the abnormality detection unit which determines whether or not the communication data has abnormality; the rule update unit which updates the detection rule on the basis of the usage status data indicating the usage status of the resource, to generate an updated detection rule in which the range of determination processes to be executed is within the remaining capacity of the resource; and the unexecuted processing management unit which, in a case where there is an unexecuted determination process not executed in the updated detection rule and the storage has a remaining capacity, executes the temporary storage process of storing the communication data and the determination rule for the unexecuted determination process into the storage. The abnormality detection unit determines whether or not the communication data has abnormality, on the basis of the updated detection rule. In a case where the temporary storage process has been executed, the abnormality detection unit executes the unexecuted determination process when the remaining capacity of the resource that enables execution of the unexecuted determination process is ensured. Thus, even in an environment with a limited resource, the range of determination processes to be executed is changed in accordance with the remaining capacity of the resource with which determination processes can be performed, whereby shortage of the resource does not occur. Thus, even under a high load, processes are not stopped and abnormality detection for communication data can be continued.

In addition, in a case where there is an unexecuted determination process in the updated detection rule, the determination process is executed at a timing when the resource has a remaining capacity. Thus, without making the processing load excessive, missing of execution in the detection rule is prevented and a monitoring process through abnormality detection for communication data can be performed.

### Embodiment 2

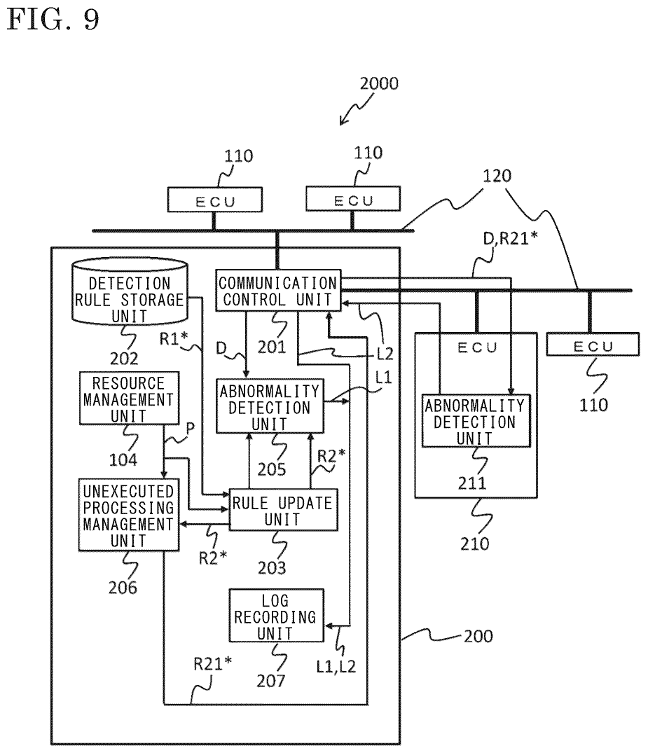

Next, embodiment 2 will be described with reference to FIG. 9 to FIG. 13. Components that are the same as or correspond to those shown in FIG. 1 to FIG. 8 are denoted by the same reference characters and the description thereof is omitted. In embodiment 2, in a case where all the determination processes are not included in the determination range, an abnormality detection unit of another device in the system executes the abnormality detection process.

FIG. 9 is a block diagram showing a configuration of an abnormality detection system in embodiment 2. An abnormality detection system 2000 is different from embodiment 1 in that an abnormality detection unit 211 which is another abnormality detection unit is provided to an BCU 210 separately from an abnormality detection device 200. The abnormality detection device 200 includes a communication control unit 201, a detection rule storage unit 202, a rule update unit 203, the resource management unit 104, and an abnormality detection unit 205. In addition, the abnormality detection device 200 includes an unexecuted processing management unit 206 and a log recording unit 207. The abnormality detection unit 205 corresponds to a “first abnormality detection unit” and the abnormality detection unit 211 corresponds to a “second abnormality detection unit”.

As shown in FIG. 1, in embodiment 2, not only the abnormality detection device 200 but also the ECU 210 includes an abnormality detection unit. That is, the ECU 210 also has a function as an abnormality detection device. As in embodiment 1, the abnormality detection device 200 may have also a function of an ECU. The abnormality detection unit 205 of the abnormality detection device 200 and the abnormality detection unit 211 of the ECU 210 may be configured without being particularly limited, as long as resources are physically or logically separated between these units and they can execute abnormality detection processes independently of each other. That is, it suffices that the resource used by the abnormality detection unit 211 and the resource used by the abnormality detection unit 205 are physically or logically separated from each other. For example, the abnormality detection unit 211 does not necessarily need to be provided to the ECU 210, and may be provided to another device connected to the in-vehicle network 120 as long as the above condition is satisfied.

Also, the ECU 210 may have any configuration capable of executing the abnormality detection process by the abnormality detection unit 211, and may be, for example, a switch, a system-on-a-chip (SOC), a virtual machine (VM), a processor having a plurality of cores, or the like.

The communication control unit 101 is basically the same as the communication control unit 101 of embodiment 1, but is different from embodiment 1 in that the communication control unit 101 transmits the communication data D which is a determination target and an unexecuted detection rule R21* to the abnormality detection unit 211 of the ECU 210, and receives a detection log L2 from the abnormality detection unit 211. The unexecuted detection rule R21* and the detection log L2 will be described later.

The detection rule storage unit 202 is the same as the detection rule storage unit 102 of embodiment 1, but stores a detection rule R1* different from that in embodiment 1. The detection rule R1* will be described later.

The rule update unit 203 is the same as the rule update unit 203 for the rule 1 of embodiment 1, but since the detection rule R1* before update is different from that in embodiment 1, an updated detection rule R2* is also different from that in embodiment 1.

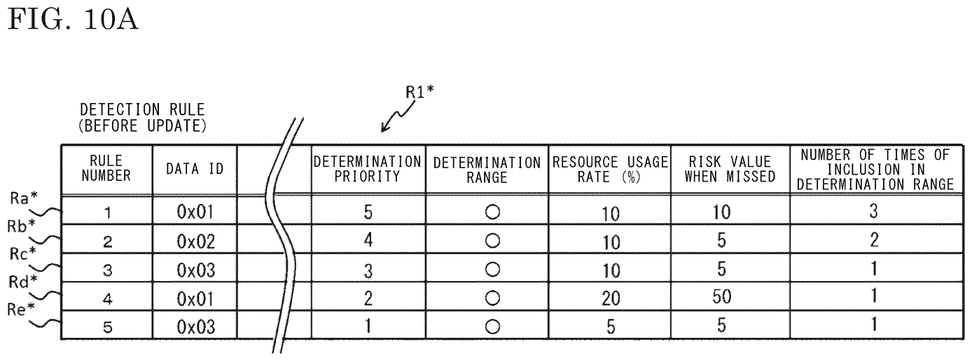

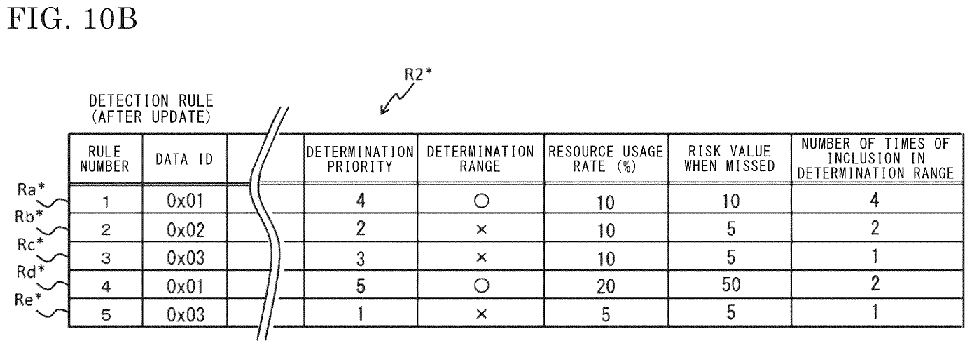

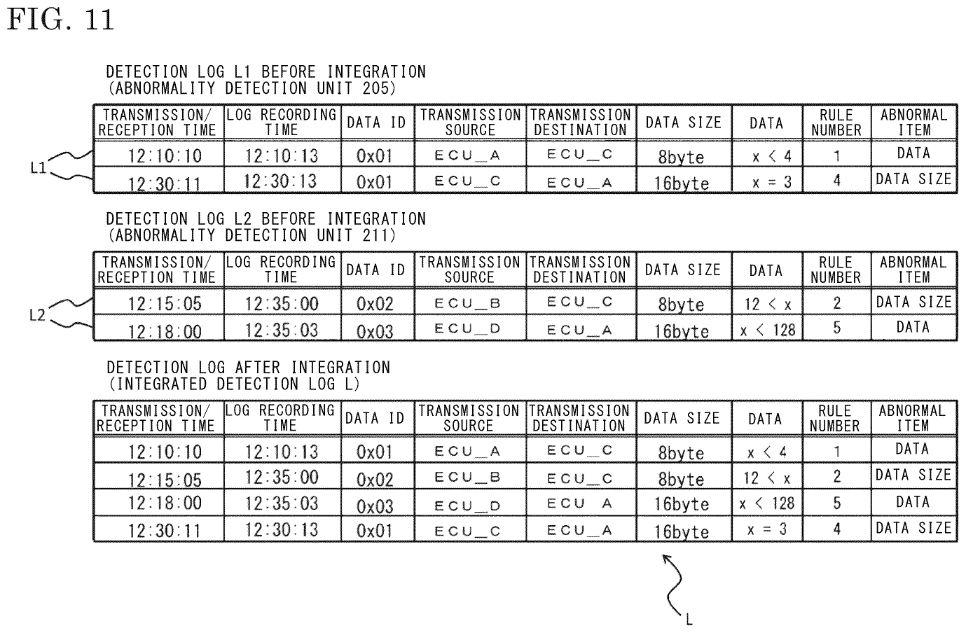

The detection rule of embodiment 2 will be described. FIG. 10A shows an example of a detection rule according to embodiment 2, which is a detection rule before update. FIG. 10B shows an example of a detection rule according to embodiment 2, which is a detection rule after update. In FIG. 10A and FIG. 10B, some of the same items as in FIG. 2A and FIG. 2B showing the detection rules in embodiment 1, specifically, the “transmission source”, the “transmission destination”, the “data size”, and the “data” are not shown. As shown in FIG. 10A and FIG. 10B, the detection rule R1* and the updated detection rule R2* include lists of determination rules composed of five determination rules Ra* to Rex, for example. Each determination rule includes the “rule number”, the “data ID”, the “transmission source”, the “transmission destination”, the “data size”, the “data”, the “determination priority”, the “determination range”, and the “resource usage rate”, as in embodiment 1.

Each determination rule Ra* to Re* further includes items “risk value when missed” and “number of times of inclusion in determination range”. The “risk value when missed” indicates the importance of the determination rule in terms of risk assessment, and is set in advance. The “number of times of inclusion in determination range” is the number of times the determination rule has been included into the determination range during a certain period, and is obtained by counting the number of times the determination rule is included into the determination range when the determination range is determined through the rule update process. In embodiment 1, determination rules are included into the determination range in the descending order of determination priority from the highest one, whereas in embodiment 2, a product of the determination priority and the risk value when detection is missed is weighted by the number of times of inclusion in the determination range, a combination of determination rules that maximizes the sum of such weighted products is calculated, and the calculated combination of determination rules is included into the determination range. In the example shown in FIG. 10B, in the updated detection rule R2, only the determination rules Ra* and Rd* are included in the determination range, and the determination rules Rb*, Rc*, and Re* are excluded from the determination range, Thus, the sum of the resource usage rates for the determination rules included in the determination range becomes 30%.

The determination priorities may be updated on the basis of a value obtained by weighting the product of the determination priority and the risk value when detection is missed by the number of times of inclusion in the determination range. For example, the determination priority of the determination rule that has been included into the determination range a smaller number of times may be increased so that the determination rule that has been included into the determination range a smaller number of times is preferentially included into the determination range. In the examples shown in FIG. 10A and FIG. 10B, it is found that the determination priorities of the determination rules Ra*, Rb*, and Rd* are updated so that the determination rules Ra* and Rd are included into the determination range. For only the determination rules Ra* and Rd* which are included in the determination range also after update, the number of times of inclusion in the determination range is increased by 1.

The above method is merely an example, and a method other than the above method may be adopted as long as determination rules to be included into the determination range are determined on the basis of at least one of the “risk value when missed”, the “determination priority”, and the “number of times of inclusion in determination range”.

Although the detection rule R1* and the updated detection rule R2* in embodiment 2 are as described above, the detection rule R1 and the updated detection rule R2 in embodiment 1 may be used in embodiment 2. Also, the detection rule R1* and the updated detection rule R2* in embodiment 2 may be used in embodiment 1.

The resource management unit 104 is the same as that in embodiment 1. The resource management unit 104 manages the usage status of the resource included in the abnormality detection device 200, and transmits data of the usage status of the resource as the usage status data P to the rule update unit 203 and the unexecuted processing management unit 206.

As with the abnormality detection unit 105 in embodiment 1, the abnormality detection unit 205 executes a determination process for the communication data D, to determine whether or not the communication data D is normal and thus determine whether or not there is abnormality, thereby detecting abnormality of the communication data D. On the basis of the updated detection rule R2*, the abnormality detection unit 205 determines whether or not the communication data D is normal, to detect abnormality. The abnormality detection unit 205 transmits a determination result as a detection log L1 to the log recording unit. The detection log L1 will be described later.

Basically, as with the unexecuted processing management unit 106 of embodiment 1, the unexecuted processing management unit 206 changes the execution method for determination processes, in a case where there is a determination rule not included in the determination range in the updated detection rule R2* and there is a determination process that has not been executed in the abnormality detection unit 205, However, the unexecuted processing management unit 106 of embodiment 1 performs processing in accordance with presence/absence of the remaining capacity of the storage 83, whereas the unexecuted processing management unit 206 performs processing in accordance with presence/absence of the remaining capacity of the communication device 84. The unexecuted processing management unit 206 receives the updated detection rule R2* from the rule update unit 203, and receives the usage status data P from the resource management unit 104. The unexecuted processing management unit 206 acquires information about the remaining capacity of the communication device 84 from the usage status data P, and executes a “transfer process” of causing the communication control unit 201 to transmit the unexecuted detection rule R21* and the communication data D which is a determination target to the abnormality detection unit 211 of the ECU 210, in accordance with the remaining capacity of the communication device 84. In the case of the updated detection rule R2* shown in FIG. 10B, the unexecuted detection rule R21* is composed of the determination rules Rb*, Rc*, and Re*. Since the communication control unit 201 is realized by the communication device 84, causing the communication control unit 201 to perform transmission corresponds to causing the communication device 84 to perform transmission.

When the unexecuted processing management unit 206 has executed the transfer process, the abnormality detection unit 211 receives the unexecuted detection rule R21* and the communication data D, and determines whether or not the communication data D has abnormality, on the basis of the unexecuted detection rule R21* That is, the abnormality detection unit 211 executes the determination processes corresponding to the determination rules Rb*, Rc*, and Re*, The abnormality detection unit 211 transmits a result of the determination processes as a detection log 12 to the log recording unit 207 via the in-vehicle network 120 and the communication control unit 201.

The log recording unit 207 acquires the detection log L1 from the abnormality detection unit 205 and the detection log L2 from the abnormality detection unit 211, integrates the detection log L1 and the detection log L2, and records the integrated log as an integrated detection log L. FIG. 11 shows examples of detection logs according to embodiment 2, which are detection logs respectively generated by different abnormality detection units and a detection log obtained by integrating the detection logs. The detection log L1, the detection log L2, and the integrated detection log L each include a “transmission/reception time”, a “log recording time”, a “data ID”, a “transmission source”,, a “transmission destination”, a “data size”, “data”, a “rule number”, and an “abnormal item”. Items to be recorded may be arbitrarily set, and other items may be adopted as long as they can be used in log analysis for identifying a cause of abnormality or the like.

The “transmission/reception time” is a time when the communication data D which is a determination target is received by the abnormality detection unit (abnormality detection unit 205 or abnormality detection unit 211). The “log recording time” is a time when each log is recorded in the log recording unit 207 (or each device). The “data ID” is a data ID of the communication data which is a determination target. The “transmission source” and the “transmission destination” indicate a device that is a transmission source and a device that is a transmission destination when the communication data D is transmitted and received via the in-vehicle network 120, The “data size” is a data size of the communication data D, and the “data” indicates a specific value or range of data. The “rule number” is a rule number of a determination rule for an executed determination process. The “abnormal item” is an item for which the communication data D matches the determination rule in the determination process, and an item that has been determined to be abnormal in the determination process corresponding to the determination rule. The detection logs shown in FIG. 11 are merely examples, and items to be recorded in the detection logs L1 and L2 may be arbitrarily set. Other items may be adopted as long as they can be used in log analysis for identifying a cause of abnormality or the like.

The log recording unit 207 sequentially receives the detection logs L1 and L2 sequentially transmitted from the abnormality detection unit 205 and the abnormality detection unit 211. When recording a new detection log, the log recording unit 207 integrates the newly received detection log with the detection logs already recorded. In the examples shown in FIG. 11, the detection logs L1 and L2 are integrated such that the logs (logs in respective rows) of the integrated detection log L which is the log after integration are arranged in the order of transmission/reception time, and thus the order of the logs and the order of the transmission/reception times are matched. In a case where the detection logs L1 and L2 are recorded without consideration of consistency, they are recorded in the order of log recording time. Here, the abnormality detection unit 205 and the abnormality detection unit 211 execute determination processes independently of each other, and the detection logs L1 and L2 are each transmitted to the log recording unit 207. Therefore, the time-series order of transmission/reception times and the time-series order of the log recording times of the communication data D do not necessarily coincide with each other. In particular, in embodiment 2, the resource used by the abnormality detection unit 205 and the resource used by the abnormality detection unit 211 are physically or logically separated from each other. Since the order of logs and the order of transmissions/receptions are matched as described above, even though the abnormality detection unit 205 and the abnormality detection unit 211 execute determination processes independently of each other, the integrated detection log L finally obtained has logs arranged in the order of transmissions/receptions of the communication data D, and therefore can be easily analyzed.

In general, in log analysis, analysis is less likely to be performed from logs in a single device, and analysis may be performed from logs in the entire system, so that time-series information on transmission/reception times of communication data can be important information in analysis. As a method for ensuring consistency of logs, the detection logs L1 and L2 relevant to each other may be collected, for example. Any method may be adopted as long as ease of analysis on logs can be enhanced in log analysis for identifying a cause of abnormality or the like.

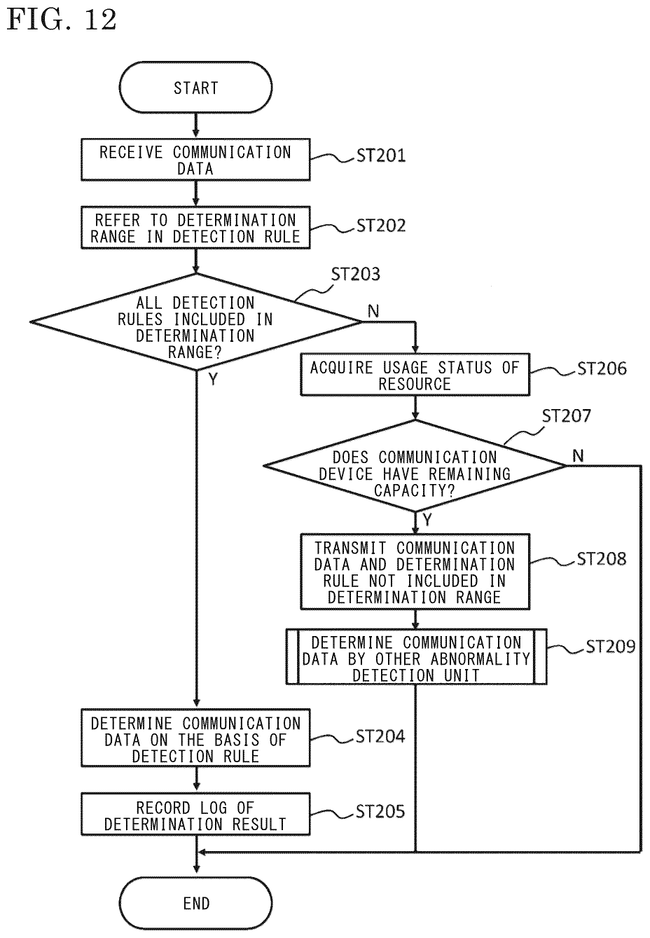

Next, operation will be described. Also in embodiment 2, the rule update process and the abnormality detection process are executed in the same manner as in embodiment 1. Regarding the rule update process, a specific update method such as performing update in consideration of the “risk value when missed” is different from that in embodiment 1, but the flow of the process is the same. In addition, the rule update process and the abnormality detection process are executed at arbitrary timings independently of each other, as in embodiment 1. Therefore, regarding operation in embodiment 2, only the abnormality detection process will be described. FIG. 12 is a flowchart showing the abnormality detection process according to embodiment 2. First, the communication control unit 201 receives the communication data D (step ST201).

Next, the abnormality detection unit 205 refers to the determination range in the detection rule (updated detection rule R2*) (step ST202).

In the updated detection rule R2*, if all the determination rules are included in the determination range, the process proceeds to step ST204, and if there is a determination rule not included in the determination range, the process proceeds to step ST206 (step ST203).

If all the determination rules are included in the determination range (step ST203: Y), the abnormality detection unit 205 performs determination for the target communication data D on the basis of the detection rule (updated detection rule R2*) (step ST204), and outputs a determination result as a detection log L1 to be recorded as an integrated detection log L by the log recording unit 207 (step ST105). In a case where there is an integrated log already recorded, the log recording unit 207 records the detection log L1 so as to be integrated with the integrated detection log L. As described above, in integrating the detection logs, the order of logs and the order of transmissions/receptions are matched.

If there is a determination rule not included in the determination range (step ST203: N), first, the usage status of the resource is acquired (step ST206). The unexecuted processing management unit 206 receives the usage status data P from the resource management unit 104, and acquires the usage status of the resource included in the abnormality detection device 200, from the usage status data P. The unexecuted processing management unit 206 determines whether or not the communication device 84 has a remaining capacity, on the basis of the acquired usage status of the resource. If the communication device 84 has a remaining capacity, the process proceeds to step ST208, and if the communication device 84 does not have a remaining capacity, the process is ended.

If the communication device 84 has a remaining capacity (step ST207; Y), the unexecuted processing management unit 206 causes the communication control unit 201 to transmit the communication data D which is a determination target and the unexecuted detection rule R21* composed of determination rules not included in the determination range in the updated detection rule R2*, to the abnormality detection unit 211 of the ECU 210 (step ST208: transfer process). The ECU 210 transmits the received communication data D and unexecuted detection rule R21* to the ECU 210.

When having received the communication data D and the unexecuted detection rule R21* from the communication control unit 201 of the abnormality detection device 200, the abnormality detection unit 211 executes the unexecuted determination processes that have not been executed by the abnormality detection unit 205, to perform determination for the communication data D (step ST209). As described above, the abnormality detection process by the abnormality detection unit 205 and the abnormality detection process by the abnormality detection unit 211 are executed independently of each other. Therefore, the processing in steps ST204 and ST205 and the processing in step ST209 are executed in parallel.

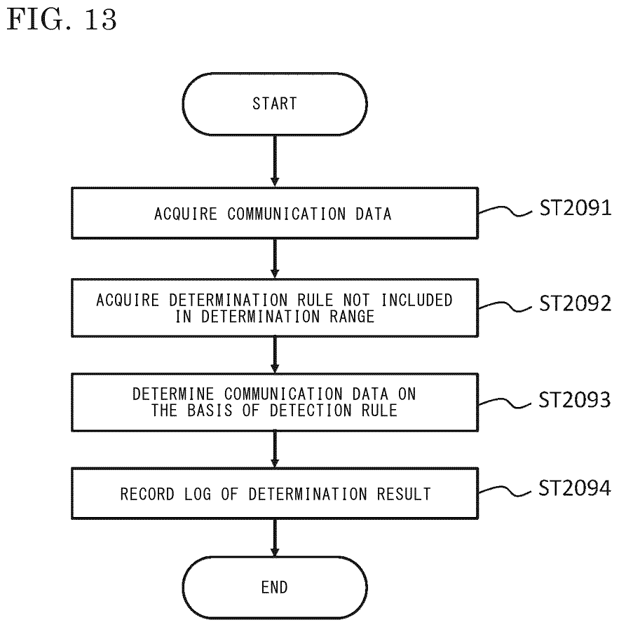

The details of the processing in step ST209 will be described. FIG. 13 is a flowchart showing operation in executing the unexecuted determination process in embodiment 2. First, the communication data D which is a determination target is acquired (step ST2091). The abnormality detection unit 211 acquires the communication data D that the ECU 210 has received from the communication control unit 201.

Next, the determination rules not included in the determination range are acquired (step ST2092). The abnormality detection unit 205 acquires the unexecuted detection rule R21* that the ECU 210 has received from the communication control unit 201, thereby acquiring the determination rules not included in the determination range in the updated detection rule R2*.

Next, determination for the communication data is performed on the basis of the detection rule (step ST2093). The abnormality detection unit 211 executes the same processing as in step ST204 performed by the abnormality detection unit 205, for the determination rules not included in the determination range.

Next, a log of a determination result is recorded (step ST2094). The abnormality detection unit 211 transmits a detection log L2 to the communication control unit 201 of the abnormality detection device 200. The communication control unit 201 transmits the received detection log L2 to the log recording unit 207. As in the case of step ST205, if there is an integrated log already recorded, the log recording unit 207 records the detection log L2 so as to be integrated with the integrated detection log L. In integrating the detection logs, the order of logs and the order of transmissions/receptions are matched.

The other matters are the same as in embodiment 1.

According to embodiment 2, the same effects as in embodiment 1 can be provided. More specifically, as in embodiment 1, the updated detection rule is generated, and the abnormality detection unit determines whether or not the communication data has abnormality, within the remaining capacity of the resource, on the basis of the updated detection rule. Further, another abnormality detection unit which uses a resource physically or logically separated from the resource used by the above abnormality detection unit, is provided. In a case where there is an unexecuted determination process not executed in the updated detection rule and the communication device has a remaining capacity, the unexecuted processing management unit executes the transfer process of transmitting the determination rule for the unexecuted determination process and the communication data to the other abnormality detection unit. When the transfer process has been executed, the other abnormality detection unit executes the unexecuted determination process. Thus, missing of execution in the detection rule is prevented. In addition, the other abnormality detection unit is provided to a device (ECU) other than the above abnormality detection device, and uses a resource separated from the resource used by the above abnormality detection unit. Therefore, even under a high load, processes are not stopped and abnormality detection for communication data can be continued, and a monitoring process through abnormality detection for communication data can be performed.

In update of the detection rule, the range of determination processes to be executed and the determination priorities are changed in accordance with the remaining capacity of the resource that can execute the determination processes, the determination priorities, and the risk values when detection is missed. Thus, even under a high load, the effect of the monitoring process can be maximally increased and the monitoring process for communication data can be continued.

In addition, in recording detection logs which are results of abnormality detections, a detection log of the abnormality detection unit and a detection log of the other abnormality detection unit are recorded so as to be integrated. In the integration, the detection logs are arranged in the order of the transmission/reception times of communication data. Thus, the order of the logs and the order of transmissions/receptions are matched, whereby ease of analysis on logs is enhanced and log analysis for identifying a cause of abnormality or the like is facilitated.

### Embodiment 3

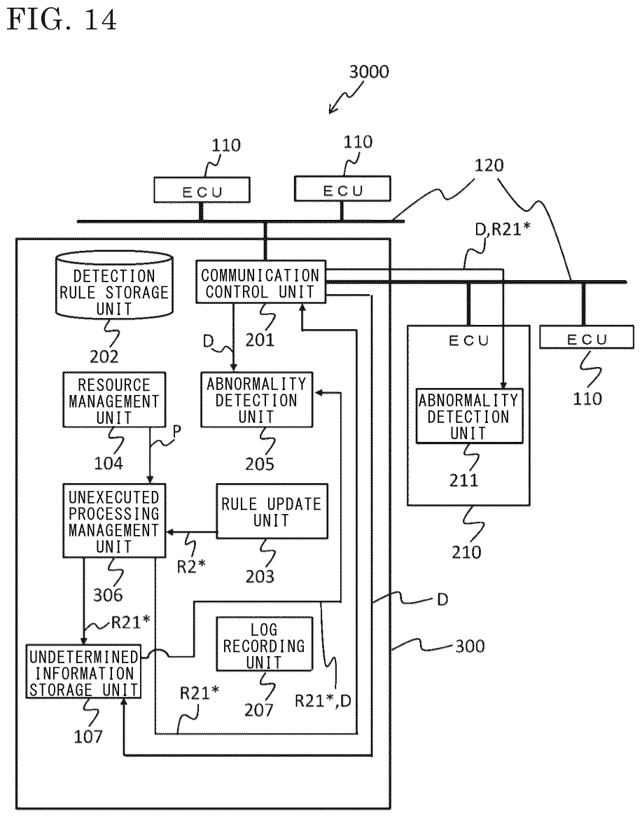

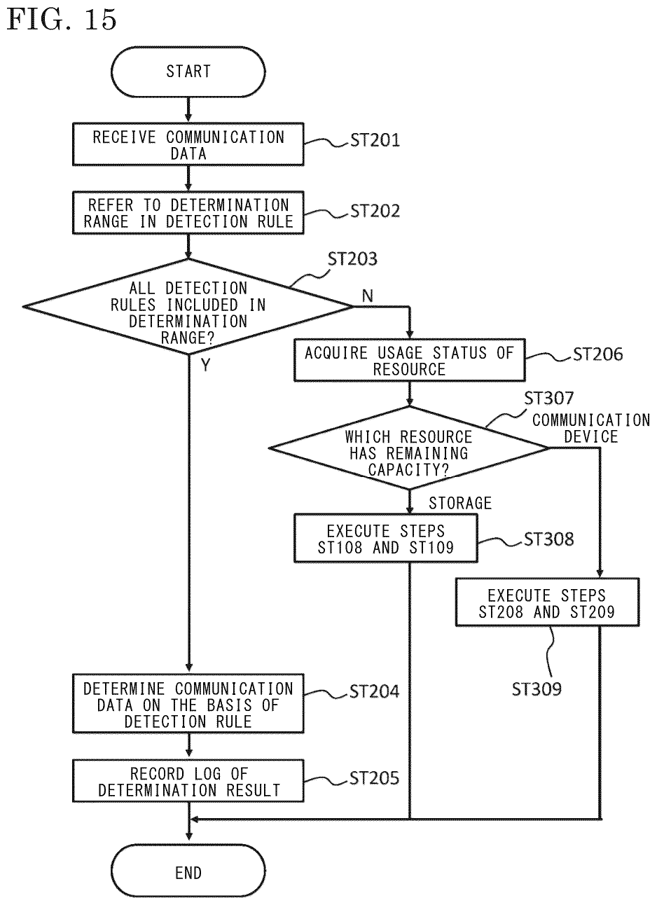

Next, embodiment 3 will be described with reference to FIG. 14 and FIG. 15. Components that are the same as or correspond to those shown in FIG. 1 to FIG. 13 are denoted by the same reference characters and the description thereof is omitted. Embodiment 3 corresponds to a combination of embodiment 1 and embodiment 2. FIG. 14 is a block diagram showing a configuration of an abnormality detection system in embodiment 3. In FIG. 14, the abnormality detection system of embodiment 3 is configured such that the configuration specific to embodiment 1 is added to embodiment 2 as a base. However, a case where the configuration specific to embodiment 2 is added to embodiment 1 as a base also exhibits the same result. For avoiding complication of the drawings, flow of data is partially omitted, but the components denoted by the same reference characters as in embodiments 1 and 2are the same as those in embodiments 1 and 2. An abnormality detection device 300 of an abnormality detection system 3000 is different from embodiment 2 in that the undetermined information storage unit 107 is provided.

An unexecuted processing management unit 306 changes the execution method for determination processes on the basis of the usage status of the resource, in a case where there is a determination rule not included in the determination range in the updated detection rule R2* and there is a determination process that has not been executed in the abnormality detection unit 205. The unexecuted processing management unit 306 receives the updated detection rule R2* from the rule update unit 203, and receives the usage status data P from the resource management unit 104. The unexecuted processing management unit 306 acquires information about the remaining capacities of the storage 83 and the communication device 84 from the usage status data P, and manages processes that have not been executed by the abnormality detection unit 205, in accordance with the remaining capacities of the storage 83 and the communication device 84.

In a case where the storage 83 has a remaining capacity, the unexecuted processing management unit 306 stores the unexecuted detection rule R21* and the communication data D which is a determination target into the undetermined information storage unit 107. Thereafter, in the same manner as with the unexecuted processing management unit 106 in embodiment 1, at the timing when it is determined that the remaining capacity of the resource (the usage rate or the processing speed of the processor 81 or the remaining capacity in the usage amount of the memory 82) needed for executing unexecuted determination processes can be ensured, the unexecuted processing management unit 306 causes the unexecuted detection rule R21* and the communication data D which is a determination target stored in the undetermined information storage unit 107 to be transmitted to the abnormality detection unit 205, and causes the abnormality detection unit 205 to execute the unexecuted determination processes.

In a case where the communication device 84 has a remaining capacity, the unexecuted processing management unit 306 transmits the unexecuted detection rule R21* and the communication data D which is a determination target to the abnormality detection unit 211 of the ECU 210 via the communication control unit 201 and the in-vehicle network 120. As in embodiment 2, the abnormality detection unit 211 executes the unexecuted determination processes (determination processes corresponding to the determination rules composing the unexecuted detection rule R21*), and transmits a result of the determination processes as a detection log L2 to the log recording unit 207 via the in-vehicle network 120 and the communication control unit 201. As in embodiment 2, the log recording unit 207 integrates the received detection log with the log already recorded, and records the integrated log as an integrated detection log L.

Next, operation will be described. Embodiment 3 is different from embodiment 2 only in the abnormality detection process. Therefore, only flow of the abnormality detection process will be described. FIG. 15 is a flowchart showing the abnormality detection process according to embodiment 3. Steps ST201 to ST206 are the same as in embodiment 2.

After having acquired the usage status of the resource in step ST206, the unexecuted processing management unit 306 determines whether the resource having a remaining capacity is the storage 83 or the communication device 84, on the basis of the usage status data P. If the resource having a remaining capacity is the storage 83, the process proceeds to step ST308, and if the resource having a remaining capacity is the communication device 84, the process proceeds to step ST309 (step ST307). If both of the storage 83 and the communication device 84 have remaining capacities, the process may proceed to either step. For example, the process may proceed to the step for the resource having a greater remaining capacity. Although not shown, if neither the storage 83 nor the communication device 84 has a remaining capacity, the process is ended.

If the storage 83 has a remaining capacity, the processing in steps ST108 and ST109 in embodiment 1 is executed (step ST308). If the communication device 84 has a remaining capacity, the processing in steps ST208 and ST209 in embodiment 2 is executed (step ST309).

The other matters are the same as in embodiment 2.

According to embodiment 3, the same effects as in embodiment 1 can be obtained when the storage has a remaining capacity, and the same effects as in embodiment 2 can be obtained when the communication device has a remaining capacity.

In the above embodiments, the case of applying the abnormality detection system and the abnormality detection device of each embodiment to ECUs has been described. However, without limitation thereto, these may be applied to a control device or a control system for a mobility such as a construction machine, an agricultural machine, a ship, a railroad vehicle, or an aircraft, or may be applied to an industrial control system in a factory, a building, an infrastructure facility, or the like.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

81 processor
82 memory
83 storage
84 communication device
100, 200, 300 abnormality detection device
101, 201 communication control unit
102, 202 detection rule storage unit
103, 203 rule update unit
104 resource management unit
105, 205, 211 abnormality detection unit
106, 206, 306 unexecuted processing management unit
107 undetermined information storage unit
110, 210 ECU
120 in-vehicle network
207 log recording unit
1000, 2000, 3000 abnormality detection system
D communication data
L integrated detection log
L1, L2 detection log
P usage status data
R1, R1* detection rule
R2, R2* updated detection rule
R21, R21* unexecuted detection rule
Ra to Re, Ra* to Re* determination rule

1. An abnormality detection device comprising:
a communication control circuitry which is connected to a network and receives communication data flowing through the network;
a detection rule storage which stores a detection rule to be used for abnormality detection for the communication data, the detection rule including determination rules indicating determination processes to be used for determining whether or not the communication data has abnormality;
an abnormality detection circuitry which determines whether or not the communication data has abnormality;
a resource status management circuitry which manages a usage status of a resource to be used by the abnormality detection circuitry, and outputs usage status data indicating the usage status of the resource;
a rule update circuitry which updates the detection rule on the basis of the usage status data, to generate an updated detection rule in which a range of the determination processes to be executed is within a remaining capacity of the resource; and
an unexecuted processing management circuitry which, in a case where there is an unexecuted determination process not executed in the updated detection rule and a storage has a remaining capacity, executes a temporary storage process of storing the communication data and the determination rule for the unexecuted determination process into the storage, wherein
the abnormality detection circuitry determines whether or not the communication data has abnormality, on the basis of the updated detection rule, and
in a case where the temporary storage process has been executed, the abnormality detection circuitry executes the unexecuted determination process when the remaining capacity of the resource that enables execution of the unexecuted determination process is ensured.

2. The abnormality detection device according to claim 1, wherein
each determination rule includes a determination priority, and
the rule update circuitry preferentially causes the determination process corresponding to the determination rule of which the determination priority is higher to be included into the range of the determination processes to be executed.

3. The abnormality detection device according to claim 2, wherein
each determination rule includes data indicating a resource amount needed for executing the determination process, and
the rule update circuitry updates the determination priorities to generate a combination of the determination rules that minimizes a difference between the remaining capacity of the resource and a sum of the resource amounts needed for the determination processes to be executed, and causes the determination processes corresponding to the combination of the determination rules to be included into the range of the determination processes to be executed.

4. The abnormality detection device according to claim 2, wherein
each determination rule includes data of a risk value when abnormality detection is missed and a number of times of inclusion in the range of the determination processes to be executed, and
the rule update circuitry generates a combination of the determination processes on the basis of at least one of the risk value, the determination priority, and the number of times, and causes the determination processes corresponding to the combination of the determination rules to be included into the range of the determination processes to be executed.

5. The abnormality detection device according to claim 1, wherein
the usage status data includes at least one data of a usage rate and a processing speed of a processor, a usage amount of a memory, a usage amount of the storage, and a communication band and a communication speed of a communication device.

6. An abnormality detection system comprising:
a communication control circuitry which is connected to a network and receives communication data flowing through the network;
a detection rule storage which stores a detection rule to be used for abnormality detection for the communication data, the detection rule including determination rules indicating determination processes to be used for determining whether or not the communication data has abnormality;
a first abnormality detection circuitry which determines whether or not the communication data has abnormality;
a second abnormality detection circuitry which uses a resource physically or logically separated from a resource to be used by the first abnormality detection circuitry;
a resource status management circuitry which manages a usage status of the resource to be used by the first abnormality detection circuitry, and outputs usage status data indicating the usage status of the resource;
a rule update circuitry which updates the detection rule on the basis of the usage status data, to generate an updated detection rule in which a range of the determination processes to be executed is within a remaining capacity of the resource; and
an unexecuted processing management circuitry which, in a case where there is an unexecuted determination process not executed in the updated detection rule and a communication device has a remaining capacity, executes a transfer process of causing the communication device to transmit the communication data and the determination rule for the unexecuted determination process to the second abnormality detection circuitry, wherein
the first abnormality detection circuitry determines whether or not the communication data has abnormality, on the basis of the updated detection rule, and
the second abnormality detection circuitry executes the unexecuted determination process in a case where the transfer process has been executed.

7. The abnormality detection system according to claim 6, wherein
in a case where there is the unexecuted determination process not executed in the updated detection rule,
when a storage has a remaining capacity and the communication device has no remaining capacity, the unexecuted processing management circuitry executes a temporary storage process of storing the communication data and the determination rule for the unexecuted determination process into the storage,
when the storage and the communication device both have remaining capacities, the unexecuted processing management circuitry selects and executes one of the temporary storage process and the transfer process,
if the temporary storage process has been executed by the unexecuted processing management circuitry, when the remaining capacity of the resource that enables execution of the unexecuted determination process is ensured, the first abnormality detection circuitry determines whether or not the communication data has abnormality by executing the unexecuted determination process, and
if the transfer process has been executed by the unexecuted processing management circuitry, the second abnormality detection circuitry determines whether or not the communication data has abnormality by executing the unexecuted determination process.

8. The abnormality detection system according to claim 6, further comprising a log recording circuitry which records a detection log which is a result obtained by determining whether or not the communication data has abnormality, wherein
in a case where the transfer process has been executed, the log recording circuitry integrates and records the detection logs respectively acquired from the first abnormality detection circuitry and the second abnormality detection circuitry.

9. (canceled)

10. The abnormality detection system according to claim 6, wherein
each determination rule includes a determination priority, and
the rule update circuitry preferentially causes the determination process corresponding to the determination rule of which the determination priority is higher to be included into the range of the determination processes to be executed.

11. The abnormality detection system according to claim 10, wherein
each determination rule includes data indicating a resource amount needed for executing the determination process, and
the rule update circuitry updates the determination priorities to generate a combination of the determination rules that minimizes a difference between the remaining capacity of the resource and a sum of the resource amounts needed for the determination processes to be executed, and causes the determination processes corresponding to the combination of the determination rules to be included into the range of the determination processes to be executed.

12. The abnormality detection system according to claim 10, wherein
each determination rule includes data of a risk value when abnormality detection is missed and a number of times of inclusion in the range of the determination processes to be executed, and
the rule update circuitry generates a combination of the determination processes on the basis of at least one of the risk value, the determination priority, and the number of times, and causes the determination processes corresponding to the combination of the determination rules to be included into the range of the determination processes to be executed.

13. The abnormality detection system according to claim 6, wherein
the usage status data includes at least one data of a usage rate and a processing speed of a processor, a usage amount of a memory, a usage amount of a storage, and a communication band and a communication speed of a communication device.

14. An abnormality detection method for detecting abnormality of communication data flowing via a network, the method comprising:
managing a usage status of a resource to be used for determining whether or not the communication data has abnormality, and outputting usage status data indicating a usage status of the resource;
updating, on the basis of the usage status data, a detection rule which is used for abnormality detection for the communication data and includes determination rules indicating determination processes to be used for determining whether or not the communication data has abnormality, and generating an updated detection rule in which a range of the determination processes to be executed is within a remaining capacity of the resource;
by a first abnormality detection circuitry, determining whether or not the communication data has abnormality, on the basis of the updated detection rule;
in a case where there is an unexecuted determination process not executed in the updated detection rule and a communication device has a remaining capacity, executing a transfer process of causing the communication device to transmit the communication data and the determination rule for the unexecuted determination process to a second abnormality detection circuitry which uses a resource physically or logically separated from a resource to be used by the first abnormality detection circuitry; and
a step of, in a case where the transfer process has been executed, executing the unexecuted determination process by the second abnormality detection circuitry.

15.-21. (canceled)

22. The abnormality detection system according to claim 7, further comprising a log recording circuitry which records a detection log which is a result obtained by determining whether or not the communication data has abnormality, wherein
in a case where the transfer process has been executed, the log recording circuitry integrates and records the detection logs respectively acquired from the first abnormality detection circuitry and the second abnormality detection circuitry.

23. The abnormality detection system according to claim 7, wherein
each determination rule includes a determination priority, and
the rule update circuitry preferentially causes the determination process corresponding to the determination rule of which the determination priority is higher to be included into the range of the determination processes to be executed.

24. The abnormality detection system according to claim 23, wherein
each determination rule includes data indicating a resource amount needed for executing the determination process, and
the rule update circuitry updates the determination priorities to generate a combination of the determination rules that minimizes a difference between the remaining capacity of the resource and a sum of the resource amounts needed for the determination processes to be executed, and causes the determination processes corresponding to the combination of the determination rules to be included into the range of the determination processes to be executed.

25. The abnormality detection system according to claim 23, wherein
each determination rule includes data of a risk value when abnormality detection is missed and a number of times of inclusion in the range of the determination processes to be executed, and
the rule update circuitry generates a combination of the determination processes on the basis of at least one of the risk value, the determination priority, and the number of times, and causes the determination processes corresponding to the combination of the determination rules to be included into the range of the determination processes to be executed.
